(19) United States
(12) Patent Application Publication
(10) Pub. No.: US 2025/0206961 A1
(43) Pub. Date: Jun. 26, 2025

(54) MATERIALS AND METHODS FOR IMPROVING AVERSIVE-AGENT COATING CONDUCTIVITY

(71) Applicant: Energizer Brands, LLC, St. Louis, MO (US)

(72) Inventor: Jingdong Guo, Westlake, OH (US)

(21) Appl. No.: 18/742,455

(22) Filed: Jun. 13, 2024

Related U.S. Application Data
(60) Provisional application No. 63/614,131, filed on Dec. 22, 2023.

(51) Int. Cl. C09D 5/24; C08K 3/04; C08K 5/20; C09D 7/61; C09D 7/63; C09D 129/04; C09D 133/02; H01M 10/04; H01M 50/109; H01M 50/548

(52) U.S. Cl. CPC C09D 5/24; C09D 7/61; C09D 7/63; C09D 129/04; C09D 133/02; H01M 10/0427; H01M 50/109; H01M 50/548; C08K 3/04; C08K 5/20; C08K 2201/001

(57) ABSTRACT

Provided are electrochemical cells with at least a portion of the exterior surface coated in a conductive aversive coating to deter children from eating the electrochemical cell. Described are compositions and methods for preparing electrochemical cells with aversive coatings capable of conducting electricity through the coating.

### CROSS REFERENCE TO RELATED APPLICATIONS

This application claims the benefit of priority to U.S. Provisional Application No. 63/614,131, filed Dec. 22, 2023, which is herein incorporated by reference in its entirety.

### FIELD

The present disclosure relates, generally, to coin or button type electrochemical cells.

### BACKGROUND

Coin cell batteries (also referred to herein as coin cells or button cells), such as those described in International Patent Publication No. PCT/US2013/021430, filed Jan. 14, 2013, the contents of which are incorporated herein by reference in their entirety, are small, disc-shaped batteries commonly used in a wide range of electronic devices, such as hearing aids, cochlear implant processors, calculators, remote controls, and wristwatches. These cells and batteries are often referred to as button cells due to their shape and size.

Accidental ingestion of coin cells by children can lead to serious injury and even death, in part due to an electrical current from the battery generating hydroxide (high pH) on the negative side through an electrolysis reaction that occurs when the battery is in contact with bodily fluids, such as tissue fluids, mucus, esophageal lining fluids, stomach fluids, or the like. The hydroxide formed causes alkaline burns and perforations of the esophagus. Serious injuries can occur in as little as two hours.

To address this issue, many manufacturers have implemented anti-swallow features. For example, anti-swallow features encompass a bitter-tasting coating on the surface of the battery that deters children from putting the battery in their mouths. However, if swallowed, a coin cell or button cell coated with a bitterant will still cause an electrolysis reaction in the esophagus or stomach and cause severe injury. Therefore, inclusion of a signal to parents or other care-givers that a battery may have been ingested may be helpful. Such signal can be achieved by use of a colorant to stain the mouth, hands, or other areas wetted by body fluids like saliva that have been in contact with a lithium coin cell.

Certain aversive agents and binders of the coatings are non-conductive materials, and therefore adding the coating to the exterior of the battery may negatively impact cell discharge performance. Accordingly, a need exists for improved coating compositions.

### BRIEF SUMMARY

Various embodiments provide electrochemical cells with a conductive aversive coating covering at least a portion of the exterior to deter children from eating the electrochemical cells. The aversive coatings have dry-weight composition comprising 0.5 wt % to 60 wt % of an aversive agent composition, 35 wt % to 90 wt % of a water-soluble polymer, and 3.0 wt % to 55 wt % of a conductive material. The aversive agent composition comprises at least one aversive taste agent and optionally a colorant. In some embodiments, the aversive taste agent is denatonium benzoate (DNB), capsaicin, allyl isothiocyanate, or piperine.

In some embodiments, the water-soluble polymer is selected from: polyvinyl alcohol (PVA), polyacrylic acid (PAA), polyacrylamide, or polyethylene glycol (PEG). In some embodiments, the water-soluble polymer is PVA. In some embodiments, the PVA has a molecular weight of about 10,000 to about 150,000. In some embodiments, the PVA is about 80% to about 95% hydrolyzed. In some embodiments, the PVA is has a molecular weight of about 75,000 and is about 88% hydrolyzed.

In some embodiments, the conductive material comprises carbon. In some embodiments, the conductive material is carbon black, graphite, expanded graphite, graphene, or carbon nanotubes. In some embodiments, the conductive material is carbon black. In some embodiments, the conductive aversive coating comprises 3.0 wt % to 30.0 wt % of the conductive material. In some embodiments, the conductive material is carbon black. In some embodiments, the conductive aversive coating comprises 12 wt % to 23 wt % of the conductive material.

In some embodiments, the aversive agent composition comprises a colorant and the aversive coating comprises 0.5 wt % to 60 wt % of the colorant. In some embodiments, the colorant comprises: FD&C Blue No. 1 (Brilliant Blue FCF), FD&C Blue No. 2 (Indigotine), FD&C Green No. 3 (Fast Green FCF), FD&C Red No. 3 (Erythrosine), FD&C Red No. 40 (Allura Red AC), FD&C Yellow No. 5 (Tartrazine), or FD&C Yellow No. 6 (Sunset Yellow). In some embodiments, the colorant is FD&C Blue No. 1.

In some embodiments, the electrochemical cell is a button cell or a coin cell. the total dry-weight amount of aversive coating applied to the electrochemical cell is about 0.2 mg to about 1.2 mg. In some embodiments, the aversive coating covers greater than 50% of the area of at least one of the positive terminal or the negative terminal. In some embodiments, the thickness of the aversive coating is greater than 1 μm. In some embodiments, the aversive coating has a conductivity greater than 0.00001 S/m. In some embodiments, the electrochemical cell with greater than 50% area of the positive terminal and/or negative terminal coated by the aversive coating maintains a resistance of less than 68,000Ω, less than 60,000Ω, less than 50,000Ω, less than 40,000Ω, less than 30,000Ω, less than 20,000Ω, less than 10,000Ω, or less than 1,000Ω. In some embodiments, the electrochemical cell is packaged in child-resistant packaging.

Various embodiments provide methods of making electrochemical cells coated in the aversive coatings. The methods comprise preparing a coating solution comprising 0.001 wt % to 5 wt % of the aversive taste agent, and 5 wt % to 18 wt % of the water-soluble polymer, and 1.0 wt % to 14 wt % of the conductive material dissolved in one or more solvents, applying the coating solution to greater than 50% of the area of the positive or negative terminal of electrochemical cells, and drying the solution onto the area of the exterior of the terminal of electrochemical cell. In some embodiments, 0.001 wt % to 18 wt % of a colorant is dissolved in the coating solution.

### BRIEF DESCRIPTION OF THE DRAWINGS

Reference will now be made to the accompanying drawings, which are not necessarily drawn to scale. The accompanying appendices, drawings, figures, images, etc. illustrate various example, non-limiting, inventive aspects, embodiments, and features (“e.g.,” or “example(s)”) in accordance with the present disclosure:

FIG. 1 is a schematic of a coin cell, according to an embodiment, submersed in a saliva solution.

FIG. 2 is a perspective and cross-sectional view of an electrochemical coin cell, according to an embodiment.

FIG. 3 is a two-dimensional cross-sectional view of the electrochemical coin cell as illustrated in FIG. 2.

FIG. 4 is a flowchart showing manufacturing steps for coating an electrochemical coin cell according to an embodiment.

FIG. 5 is a perspective and cross-sectional view of an electrochemical coin cell having a conductive aversive coating applied to the negative terminal, according to an embodiment.

FIG. 6 illustrates an example child-resistant packaging according to one embodiment.

### DETAILED DESCRIPTION

Coin cell batteries, also known as button cells, are small, single-cell batteries that are typically used to power low-power devices such as watches, calculators, hearing aids, and small electronic devices. These batteries are small and compact, making them easy to use and store, and are available in a wide variety of sizes, chemistries, and voltage ratings.

Coin cell batteries were initially developed for use in hearing aids and are now used in a variety of other applications and devices, such as watches, calculators, and other small electronic devices. Coin cell batteries typically consist of a positive electrode (cathode), a negative electrode (anode), and an electrolyte that allows the flow of ions between the electrodes. The electrodes and electrolyte are enclosed in a small, circular metal casing that is typically made from stainless steel or nickel-plated brass.

The positive electrode is typically made from a metal oxide, such as silver oxide or manganese dioxide, and is coated onto a metal grid or foil. The negative electrode is typically made from a metal such as zinc or lithium and is also coated onto a metal grid or foil. The electrolyte is typically a liquid or gel and is designed to allow the flow of ions between the electrodes.

The electrodes and electrolyte are arranged in a specific configuration within the metal casing, depending on the battery chemistry and voltage rating. For example, in a silver oxide-based battery, the positive electrode is placed in the center of the battery, while the negative electrode is placed around the outside of the positive electrode. This arrangement allows the battery to deliver a high voltage output while maintaining a small size.

External components include a shell or housing defining an inner volume in which the anode and electrode are housed, kept physically apart by a separator, such as an ion-permeable separator, an electrolyte-permeable separator, or the like. The anode and cathode have different active materials, such as zinc and manganese dioxide, respectively. These materials are selected for their electrochemical properties that allow them to facilitate the flow of electrons from one terminal to the other. The electrolyte is a liquid or gel substance that allows for the movement of ions between the anode and cathode. The electrolyte is often a combination of a salt, such as potassium hydroxide, and water.

Coin cell batteries are available in a wide variety of chemistries, each with its own unique performance characteristics. For example, alkaline coin cell batteries are the most common type of button cell battery and are typically used in low-power devices such as watches, calculators, and small electronic devices. These batteries use an alkaline electrolyte and a zinc-based negative electrode and are available in a wide variety of sizes and voltage ratings. Silver oxide coin cell batteries are typically used in high-power devices such as cameras, calculators, and medical equipment. These batteries use a silver oxide positive electrode and a zinc-based negative electrode and are designed to deliver a high voltage output and long life. Zinc-air coin cell batteries are typically used in hearing aids and use a zinc-based negative electrode and air as the positive electrode. However, these battery chemistries often have drawbacks such an off-gassing risk, explosion risk, fire risk, reduced battery life, inconsistent discharge, discharge temperature change issues, and others. Lithium is a popular alternative to other conventional battery chemistries, especially for use in low-power devices such as watches, calculators, and small electronic devices that use coin cell batteries. These batteries typically use a manganese oxide-based positive electrode and a lithium-based negative electrode.

However, accidental ingestion of coin cells by children can lead to serious injury and even death, in large part due to an electrical current from the battery generating hydroxide (high pH) on the negative terminal or contact. The electrical current at the negative terminal or contact can cause an alkalizing reaction and/or electrolysis reaction when the negative terminal or contact of the battery is in contact with bodily fluids, such as saliva, tissue fluids, mucus, esophageal lining fluids, stomach fluids, or the like. Hydroxides formed during the electrolysis reactions causes alkaline burns and perforations of the mouth, esophagus, stomach lining, and/or intestines. Serious injuries can occur in as little as two hours after ingestion.

To address the dangers inherent in the small size of coin-cell batteries, manufacturers have implemented anti-swallow features. One common anti-swallow feature is a raised border around the circumference of the button cell battery. This border makes it more difficult for a child to swallow the battery, but may only help reduce ingestion by infants, whereas toddlers can still ingest button cell batteries having a raised border about the circumference of the button cell battery. Some manufacturers coat button cell batteries in one or more bitterants, which are bitter-tasting substances, to deter children from putting the button cell battery in their mouths. However, not all infants, toddlers, or even older children are dissuaded from putting a button cell battery coated with a bitterant in their mouth. If swallowed, a coin cell battery or button cell battery, whether coated with a bitterant or having a raised circumferential border, or otherwise modified to dissuade or prevent swallowing behaviorally, will still cause an electrolysis reaction in the child's mouth, esophagus, stomach, or intestines, and will still cause severe injury or death. Therefore, inclusion of a signal to parents or other care-givers that a battery may have been ingested is a critical feature. Such signal can be achieved by use of a colorant to stain the mouth, hands, or other areas wetted by body fluids like saliva that have been in contact with a lithium coin cell.

The principal electrochemical reaction that occurs upon ingestion of a coin cell battery is electrolysis of water because the following factors are present: (a) the coin cell itself supplies a DC voltage, ˜3V OCV (open circuit voltage); (b) an ionic conductive media (saliva) connects the anode (+) and cathode (−) terminal; and (c) the two terminals and saliva conducting path complete a closed circuit for an electrolysis cell. If the voltage supply of the electrolysis cell is high enough to overcome the polarization and the 1.23V thermodynamic voltage window for water electrolysis, electrochemical reactions will occur. Indeed, the electrolysis reaction associated with the ingestion of lithium cells is likely more severe than the electrolysis associated with ingestion of alkaline cells. This is because the driving force (the difference in voltage between the cell voltage and theoretical water electrolysis voltage, 1.23 V) is much higher in the case of a 3V lithium cell than in the case of a 1.5V alkaline cell (3.0V-1.23V=1.77V in the case of a lithium cell vs. 1.5V-1.23V=0.27V in the case of an alkaline cell).

Significantly, the nomenclature for an electrolysis cell is the opposite of that used for a battery. Accordingly, the terms “anode” and “electrolysis anode” refer to the electrode subject to an oxidation reaction and the terms “cathode” and “electrolysis cathode” refer to the electrode subject to the reduction reaction. When an electrolysis cell, such as a coin cell, is assembled and active electrochemical components are sealed within the cell, the negative terminal will be in electrical communication with the anode or electrolysis anode, while the positive terminal will be in electrical communication with the cathode or electrolysis cathode. Also, it should be noted that electrolysis requires application of voltage and, as such, provides a direct contrast to corrosion which typically occurs naturally under ambient conditions.

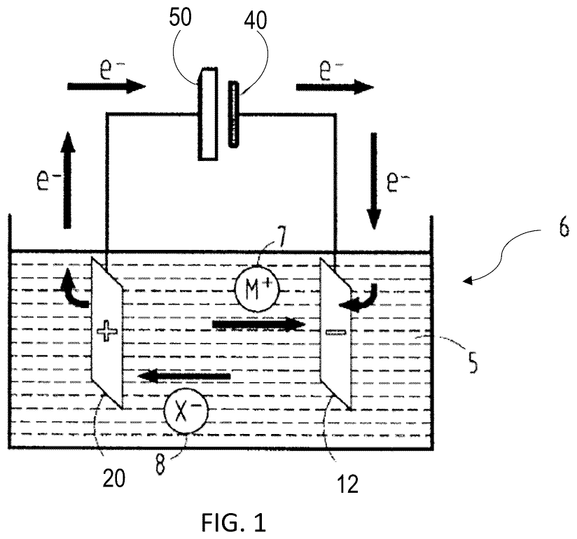

FIG. 1 helps illustrate the electrolysis reaction at issue. A simulated Li—MnO₂ electrochemical coin cell 6 submerged in saliva solution 5. The principal reactions that occur when a cell having these same components is accidentally ingested and lodged in the esophagus of a human are shown, although the cell electrodes are shown as discrete parts. Specifically, cell 6 operates at approximately 3V DC and includes coin cell cup (e.g., the positive electrode container) 12, coin cell can (e.g., the negative electrode container) 20, anode 40 and cathode 50. The anode 40 and cathode 50 comprise materials specifically selected for their compatibility with an intended electrochemical reaction; for example, x Li+MnO₂→Li—MnO₂, in which the Mn undergoes a reduction as the lithium ion enters into the crystal lattice.

The external surface of the coin cell cup 12 acts as the negative terminal (cathode in an electrolysis cell) and the external surface of the coin cell can 20 acts as the positive terminal (anode in an electrolysis cell). A hydrogen gas evolution reaction takes place on coin cell cup 12 by accepting electrons from battery anode 40, which in this case includes lithium. At the coin cell can 20 (anode in an electrolysis cell), multiple reactions such as metallic dissolution, oxygen gas evolution and possibly chloride oxidation occur and compete with one another. Charge neutrality in saliva solution 5 is preserved by the movement of anions 8 from the cell cup 12 (negative terminal) toward coin cell can 20 (positive terminal) and by the movement of cations 7 in the opposite direction. As metal from coin cell can 20 oxidizes, it loses electrons to battery cathode 50, which is manganese dioxide in this case. Ultimately, the final product at the coin cell can 20 depends on its potential and the solution pH is a consequence of the combined anode and cathode reactions. Further, the solution pH reflects real time product generated in the reaction zone between the esophagus and coin cell; therefore, the solution pH is localized and not necessarily reflective of the pH of the bulk solution (i.e., the remainder of the saliva which is not proximate to the reaction zone).

Possible electrochemical reactions on the coin cell cup 12 (negative terminal) are shown below when a 3 V lithium coin cell is immersed in a neutral or alkaline saliva solution. Note that the saliva is usually neutral.

$$2 {H}_{2} O + 2 {e}^{-} \to H 2 ↑ + 2 {OH}^{-} {E}_{0} = - 0 \text{.83} V \qquad ( 1 )$$

$${O}_{2} + 2 {H}_{2} O + 4 {e}^{-} \to 4 {OH}^{-} {E}_{0} = - 0.4 V \qquad ( 2 )$$

Typically, reaction (1) dominates because the concentration of oxygen in the saliva is too low as the solubility of oxygen in water is limited. Either way, the production of hydroxyl ions (i.e., OH⁻) increases the pH of the saliva, potentially to a point that may cause alkaline burning of the esophagus.

On occasion, saliva may be acidic in nature. In such situations, the reactions at the coin cell cup 12 are shown below:

$$2 {H}^{+} + 2 {e}^{-} \to {H}_{2} ↑ {E}_{0} = - 0. V \qquad ( 1 a )$$

$${O}_{2} + 4 {H}^{+} + 4 {e}^{-} \to 2 {H}_{2} O {E}_{0} = 1.23 V \qquad ( 2 a )$$

In either case, selection of materials for use at the negative terminal with high hydrogen gas evolution overpotential will shift the dominant reaction from (1) and (2) to (1a) and (2a). This has the beneficial effect of reducing or eliminating the hydroxyl formation that can cause localized alkaline burning of esophageal tissues.

Possible electrochemical reactions on the coin cell can 20 (positive terminal) are shown below when a 3V lithium coin cell is immersed in saliva solution 5 and coin cell can 20 comprises nickel at least partially along its surface.

$$4 {OH}^{-} - 4 {e}^{-} \to {O}_{2} ↑ + 2 {H}_{2} O \qquad ( 3 )$$

$$Ni - 2 {e}^{-} + 2 {OH}^{-} \to {Ni ( OH )}_{2} \qquad ( 4 )$$

Reaction (4) usually dominates so that the metal constituents in coin cell can 20 tend to oxidize. Indeed, lithium electrochemical coin cell cans are typically nickel-plated, as exemplified by the oxidation of nickel in reaction (4). If coin cell can 20 is composed of other metals, e.g., stainless steel, the iron in these alloys likely will oxidize in a similar reaction. Once the metal surface of coin cell can 20 has been passivated (i.e., by formation of a dense oxide film on the bare metal surface), the oxygen evolution reaction (3) will likely dominate if the voltage is sufficiently high.

Moreover, as shown below in (3a) and (4a), dissolution of the metal can 20 is also a probable result if the ferrous base metal (normally some type of steel) is exposed and especially to the extent that hydroxide is present (e.g., by way of the aforementioned competing reactions) and/or in an acidic environment (e.g., by way saliva).

$$\begin{matrix}Fe - 2 {e}^{-} - {{Fe}^{2 +}}_{} & ( in acidic media )\end{matrix} \qquad ( 3 a )$$

$$\begin{matrix}Fe - 2 {e}^{-} + 2 {OH}^{-} \to {Fe ( OH )}_{2} & ( in alkaline media )\end{matrix} \qquad ( 4 a )$$

Any combination of the cathodic processes in reactions (1) through (2a) and anodic processes in reactions (3) through (4a) can complete the electrolysis cell 6 depicted in FIG. 1. For example, the combination of (1) and (3) leads to the following electrolysis reaction in water (i.e., water splitting):

$$2 {H}_{2} O \to {H}_{2} ↑ + {O}_{2} ↑ {E}_{0} = - 1 \text{.23} V \qquad ( 5 )$$

Note that electrolysis reaction (5) has a thermodynamic potential of 1.23 V and the negative sign for ΔE₀ denotes that the reaction is not spontaneous. Consequently, a DC power source of at least 1.23 V is needed to initiate and sustain reaction (5) and as depicted in FIG. 1, coin cell 6 supplies 3V DC.

Furthermore, if the amount of sodium chloride (NaCl) in the saliva is relatively high, the following electrolysis reaction may occur instead of reaction (5) (discussed earlier):

$$2 NaCl + 2 {H}_{2} O \to {Cl}_{2} ↑ + {H}_{2} ↑ + 2 NaOH \qquad ( 6 )$$

In reaction (6), one of the products is sodium hydroxide (NaOH), another contributor to high solution pH and a potentially alkaline solution that may be capable of burning human tissue.

In sum, the conventional electrochemical coin cell 6 depicted in FIG. 1, and the reactions (1) through (6) associated with its submersion in saliva 5, demonstrate that hydroxide ions are formed from some iteration of electrolysis. Thus, the burns and injuries caused when a coin cell becomes accidentally lodged in the esophagus is likely caused by the high saliva pH created during these reactions, although the reactions and corresponding impact on pH may be highly localized and difficult to detect if the pH is not measured in close proximity to the components at issue. Stated differently, because of mass transport limitations in the esophagus, a person with a lodged coin cell may experience different pH values for the tissue interacting with coin cell can 20 (positive terminal) and the tissue interacting with coin cell cup 12 (negative terminal), with higher pH solutions facing the negative terminal (i.e., coin cell cup 12 in FIG. 1) because of diffusion limitations of the liquids within the esophagus.

To the extent certain aspects of various embodiments of the present disclosure and underlying concepts involve saliva and/or saliva-based aqueous solutions, saliva can be represented by the following composition: 0.4 g KCl; 0.4 g NaCl; 0.906 g CaCl₂); 0.560 g Na₃PO₄⁻12H₂O; 2 ml 10% H₃PO₄; 0.0016 g Na₂S; 1 g urea; and a balance of de-ionized water to make 1 liter of solution. While this formulation is intended to approximate human saliva in a manner that is standardized, small variations and/or actual human saliva may be used as substitutes although, in such instances, deviations from the representative formulation will be duly noted.

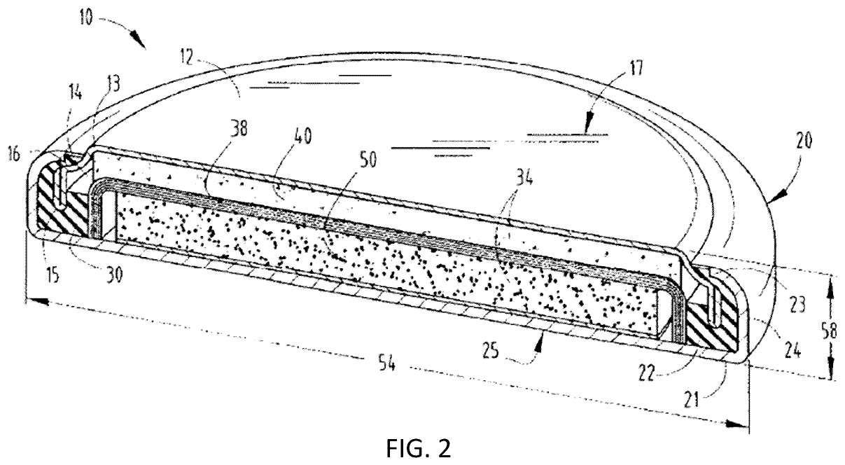

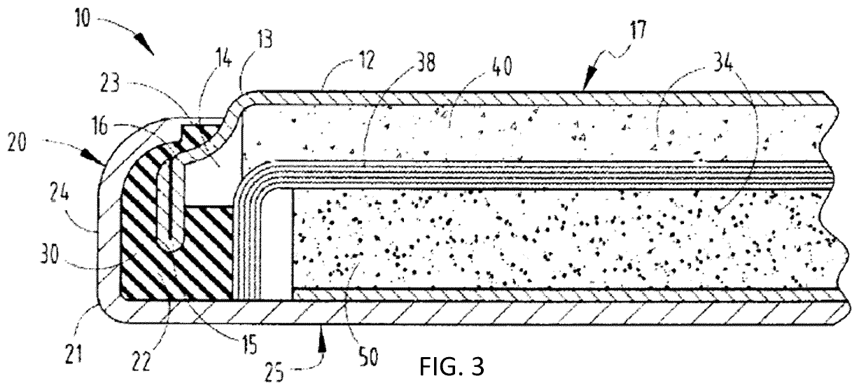

FIGS. 2 and 3 depict one arrangement for an electrochemical coin cell 10 that is well-suited to aspects and embodiments of the present disclosure, although the coin cell 10 may assume various alternative orientations and arrangements of components. Further, the specific devices and processes illustrated in the attached drawings and described herein are exemplary embodiments of the inventive concepts defined in the appended claims. Hence, precise dimensions and physical characteristics relating to the embodiments disclosed herein are not to be considered as limiting except to the extent that such dimensions or characteristics are inherent to producing the desired reactions.

The electrochemical coin cell 10, as depicted in FIGS. 2 and 3, also includes a cathode terminal 20 (i.e., the cell can) including a closed end 21, an open end 22 with a terminal edge 23, and a side wall 24 extending between closed end 21 and open end 22. Cathode terminal 20 serves as the positive electrode for the coin cell. In addition, cathode terminal 20 comprising a metallic material, such as titanium, a titanium alloy, titanium nitride, tantalum, niobium, stainless steel, gold, boron-doped diamond, or another electronic conductor. Closed end 21 may also be provided with a composition comprising titanium metal, a titanium alloy, titanium nitride, tantalum, niobium, stainless steel, gold, boron-doped diamond, or another electronic conductor.

Coin cell 10 further includes a gasket 30 that provides a seal between anode terminal 12 and cathode terminal 20 (FIGS. 2 and 3). The gasket 30 is typically made from an electrically nonconductive, elastomeric material, capable of providing a compressive seal between anode terminal 12 and cathode terminal 20. The material used for gasket 30 must also be selected with reference to its stability in the presence of an electrolyte, its resiliency and its resistance to cold flow. Suitable materials for gasket 30 include the following: nylon, polytetrafluoroethylene, fluorinated ethylene-propylene, chlorotrifluoroethylene, perfluoroalkoxy polymer, polyvinyls, polyethylene, polypropylene, polystyrene, polysulfone and the like.

The electrochemical coin cell 10 also includes an electrolyte 34. Various materials can be employed for electrolyte 34 as understood by one with ordinary skill in the art. For example, electrolyte 34 may be composed of a composition of at least one lithium salt dissolved in an organic solvent or a blend of organic solvents. Suitable salts for use in lithium coin cells are lithium trifluoromethanesulfonate, lithium trifluoromethanesulfonimide, lithium perchlorate, lithium tetrafluoroborate, lithium hexafluorophosphate, or their combination. Common organic solvents used in lithium coin cells are propylene carbonate and 1,2-dimethoxyethane.

The electrochemical cell 10 also has an anode 40 disposed in electrical connection with anode terminal 12. As understood by those with ordinary skill in the art, the anode 40 can be composed of various alkaline metals and their alloys with aluminum or magnesium provided that the composition is suitable for serving as an anode in an electrochemical cell. In one embodiment, anode 40 is primarily composed of lithium material suitable as an anode in an electrochemical cell with a cathode that consists primarily of manganese dioxide.

Electrochemical cell 10 also includes cathode 50 arranged to be in electrical connection with cathode terminal 20. As also understood by those with ordinary skill in the art, cathode 50 can be composed of various materials suitable for use as a cathode in a lithium-based electrochemical cell. In one embodiment, cathode 50 is primarily composed of manganese dioxide.

Electrochemical coin cell 10 further includes a separator 38 disposed between anode 40 and cathode 50 for providing insulation therebetween. Separator 38 can be composed of any of a variety of polymeric materials, for example, that provide electrical insulation between anode terminal 12 and cathode terminal 20. For example, separator 38 may be formed from a polypropylene or polyethylene nonwoven film with thickness of between about 20 μm and about 60 μm.

As also demonstrated by FIGS. 2 and 3, electrochemical cell 10 can be configured in a button- or coin-cell configuration with a total cell external diameter 54 and total cell height 58. The total cell external diameter 54 may be sized from between about 5 mm and about 25 mm and the total cell height 58 may be between about 0.5 mm and about 10 mm. It is generally understood that button or coin cells with these dimensions are most likely to lodge in the esophagus upon accidental ingestion. For example, electrochemical cell 10 may be made in a CR2016 configuration as defined by the International Electrotechnical Commission (IEC) with total cell external diameter 54 having a diameter of about 20 mm and total cell height 58 having a thickness of about 1.6 mm.

Another aspect of the disclosed approach relates to a method of constructing and/or manufacturing a coin cell having the features discussed herein. The method comprises providing a negative electrode active material comprising lithium and disposing said materials in separate halves of an electrically conductive container and providing a nonaqueous, organic liquid electrolyte prior to hermetically sealing the halves of the conductive container to create a battery.

Another aspect of the disclosed approach is the provision and/manufacture of a battery to avoid/mitigate injuries associated with ingestion of said battery, as well as a method for avoiding/mitigating injuries caused by battery ingestion. In these aspects, any of the aforementioned battery designs and constructions may be provided. At their core, the inventive method involves manufacturing an battery and providing said battery for sale and/or use by a consumer.

Non-conductive aversive coatings and methods of preparing electrochemical cells with aversive coatings are described in U.S. Nonprovisional application Ser. No. 18/593,391, filed Mar. 1, 2024; U.S. Nonprovisional application Ser. No. 18/593,527, filed Mar. 1, 2024; U.S. Nonprovisional application Ser. No. 18/593,533, filed Mar. 1, 2024; and U.S. Nonprovisional application Ser. No. 18/593,561, filed Mar. 1, 2024, which are herein incorporated by reference in their entirety.

### Conductive Aversive Coatings

Aspects of the disclosure relate to conductive aversive coatings for electrochemical cells. A conductive aversive coating is formed by applying a solution comprising an aversive agent, a conductive material, and a binder, such as a water-soluble polymer onto a surface (e.g., a surface of a battery) and drying or curing the solution. The aversive coating comprises at least one aversive agent, which can be an aversive taste agent such as a bitterant, an aversive smell agent, and/or a salivating agent. An “aversive taste agent” refers to a substance which is bitter, sour, spicy, peppery, or otherwise undesirable in flavor to deter children from eating a battery. An “aversive smell agent” is an odiferous substance with an undesirable smell, such as ammonia or sulfur. A “salivating agent” refers to a substance which induces the production of saliva when in contact with the mouth. The aversive agent composition may also comprise a colorant to alert parents that a child has tried to consume a battery.

In some embodiments, the aversive coating has a dry-weight composition comprising 0.5 wt % to 7.0 wt % of an aversive taste agent, 35 wt % to 90 wt % of a water-soluble polymer, and 3.0 wt % to 55 wt % of a conductive material. In some embodiments, the aversive coating further comprises one or more additives balancing the dry-weight composition.

The aversive coating comprises at least one aversive taste agent (e.g., a bitterant). In some embodiments, the aversive taste agent is selected from: denatonium benzoate (DNB), capsaicin, allyl isothiocyanate, or piperine. In some embodiments, the aversive taste agent is DNB. In some embodiments, the aversive coating has a dry-weight composition comprising 0.5 wt % to 7.0 wt % of the aversive taste agent. In some embodiments, the aversive coating has a dry-weight composition comprising about 0.5 wt % to about 7.0 wt % DNB. In some embodiments, the aversive coating has a dry-weight composition comprising about 2.0 wt % to about 5.0 wt % DNB.

The water-soluble polymer contained in the aversive coatings acts as a binder to adhere the aversive agent compositions to the electrochemical cell. In some embodiments the dry-weight composition of the aversive coating comprises 35 wt % to 90 wt %, 35 wt % to 85 wt %, 35 wt % to 80 wt %, 35 wt % to 75 wt %, 35 wt % to 70 wt %, 35 wt % to 65 wt %, 35 wt % to 60 wt %, 35 wt % to 55 wt %, 35 wt % to 50 wt %, or 35 wt % to 45 wt % of the water-soluble polymer.

In some embodiments, the water-soluble polymer is selected from: polyvinyl alcohol (PVA), polyacrylic acid (PAA), polyacrylamide, or polyethylene glycol (PEG). In some embodiments the water-soluble polymer is PVA. In some embodiments, the water-soluble polymer has a molecular weight of about 10,000 to about 150,000, about 10,000 to about 100,000, about 50,000 to about 100,000, about 60,000 to about 90,000, about 70,000 to about 80,000, or about 75,000. In some embodiments, the PVA has a molecular weight of about 50,000 to about 100,000. In some embodiments, the PVA has a molecular weight of about 10,000 to about 150,000, about 10,000 to about 100,000, about 50,000 to about 100,000, about 60,000 to about 100,000, about 60,000 to about 90,000, about 70,000 to about 100,000, about 70,000 to about 90,000, or about 70,000 to about 80,000. In some embodiments, the PVA has a molecular weight of about 75,000. In some embodiments, the PVA has a molecular weight of about 72,000. All molecular weights are described as an average mass in grams per mole.

Polyvinyl alcohol is prepared from polyvinyl acetate by hydrolyzing ester functional groups to hydroxyl functional groups. The degree to which polyvinyl alcohol has been hydrolyzed can vary. For PVA that has been 80% hydrolyzed, approximately 80% of the monomer units contain hydroxyl groups and approximately 20% of the monomer units contain acetate. In some embodiments, the PVA is about 70% to 100% hydrolyzed, about 70% to about 99% hydrolyzed, about 80% to about 99% hydrolyzed, about 85% to about 95% hydrolyzed, about 80% to about 90% hydrolyzed, or about 85% to about 90% hydrolyzed. In some embodiments, the PVA is about 80% to about 95% hydrolyzed. In some embodiments, the PVA is about 88% hydrolyzed. In some embodiments, the PVA has a molecular weight of about 75,000 and is about 88% hydrolyzed.

The aversive coatings include a conductive material added in a sufficient concentration to exceed the percolation threshold for the polymeric matrix, allowing for the conduction of electricity through the coating. The percolation threshold is the concentration of the solid conductive material above which the electrical conductivity of the composition increases exponentially. At the percolation threshold, conductive particles are in electrical contact with one another within the coating, thereby creating conductive pathways through the coating. As the concentration of conductive material increases above the percolation threshold, the number of conductive pathways increases, thereby increasing the conductivity of the overall coating. The conductive material allows the flow of electric current through the material. The conductive material may be metal or non-metal. The conductive material can be natural, i.e., mined, or synthetic, i.e., manufactured.

In some embodiments, the conductive material comprises carbon. In some embodiments, the conductive material is carbon black, graphite, expanded graphite, graphene, or carbon nanotubes. In some embodiments, the conductive material is carbon black. Carbon black is a form of amorphous carbon obtained from the partial combustion of hydrocarbons. Graphene is composed of a single layer of sp²-hybridized carbon atoms with trigonal planar geometry bound in a hexagonal honeycomb lattice structure. Graphite is a crystalline form of carbon comprising multiple stacked layers of graphene. Graphite is naturally occurring in metamorphic rocks, but synthetic graphite can also be produced at high temperatures. The relatively weak van der Waals forces which include x-x interactions between layers of graphite can be dissociated by thermal or mechanical treatment and/or intercalation with another chemical to produce expanded graphite (or expandable graphite). For example, natural graphite can be treated with acid and an oxidizing agent and heated to produce expanded graphite with an increased volume. The conductive material may comprise expanded or non-expanded graphite. Suppliers of graphite include Timcal America of Westlake, Ohio; Superior Graphite Company of Chicago, Ill.; and Lonza, Ltd. of Basel, Switzerland.

Carbon nanotubes are an allotrope of carbon having a hollow tube structure with sp²-hybridized carbon atoms in a trigonal planar geometry bound in a hexagonal honeycomb lattice (i.e., rolled up graphene structure). Carbon nanotubes can be single-walled, typically with a diameter of 0.5 to 2.0 nm, or they can be multi-walled with multiple concentric layers of nested tubes, which can have larger diameters, such as 7 to 100 nm. The typical length of carbon nanotubes is in the range of hundreds of nanometer to tens of micrometers, but they can be up to around 1 mm long.

In some embodiments, the dry-weight composition of the aversive coating comprises 3 wt % to 55 wt % of the conductive material. In some embodiments, the dry-weight composition of the aversive coating comprises 6 wt % to 55 wt % of the conductive material. In some embodiments, the dry-weight composition of the aversive coating comprises 9 wt % to 30 wt % of the conductive material. In some embodiments, the dry-weight composition of the aversive coating comprises 12 wt % to 23 wt % of the conductive material. In some embodiments, the dry-weight composition of the aversive coating comprises 12 wt % to 23 wt % of carbon black.

Dry weight concentrations of 3 wt % to 55 wt % of a conductive material may be sufficient to exceed the percolation threshold of an aversive coating, allowing for the conduction of electricity. The percolation threshold may vary based on the specific composition of the conductive material, the water-soluble polymer, and the aversive agents in the coating. For example, aversive coatings with a particular type of carbon nanotube as the conductive material may have a different percolation threshold than a comparable aversive coating with carbon black as the conductive material. In a similar manner, an aversive coating with PVA as the water-soluble polymer may have a different percolation threshold than a comparable coating with PAA as the water-soluble polymer. Thus, conductive aversive coatings may have different ranges of concentrations of conductive materials to exceed the percolation threshold based on the specific components. The minimum amount of a conductive material necessary to exceed the percolation threshold can be determined for a particular conductive material as described herein.

In some embodiments, the aversive coating further comprises a colorant. In some embodiments the dry-weight composition of the aversive coating comprises 0.5 wt % to 60 wt % of a colorant. In some embodiments the dry-weight composition of the aversive coating comprises 5 wt % to 55 wt %, 10 wt % to 55 wt %, 20 wt % to 55 wt %, 30 wt % to 55 wt %, 35 wt % to 55 wt %, 35 wt % to 50 wt %, or 35 wt % to 45 wt % of the colorant. In some embodiments, the colorant comprises FD&C Blue No. 1 (Brilliant Blue FCF), FD&C Blue No. 2 (Indigotine), FD&C Green No. 3 (Fast Green FCF), FD&C Red No. 3 (Erythrosine), FD&C Red No. 40 (Allura Red AC), FD&C Yellow No. 5 (Tartrazine), or FD&C Yellow No. 6 (Sunset Yellow). In some embodiments, the aversive coating comprises FD&C Blue No. 1.

In some embodiments, one or more additives of the aversive coating comprise an adhesion promoter. The addition of an adhesion promoter may help the aversive coating to better adhere to the surface of an electrochemical cell. In some embodiments, the dry-weight composition of the aversive coating comprises 0.1 wt % to about 5.0 wt % of the adhesion promoter. In some embodiments, the adhesion promoter is Lubrizol 2063, Lubrizol 2062, DowSil Z-6137, DowSil 3-6121, PP-6 (PP water from Marabin Environmental Conservation Printing Ink Co. Ltd), BYK-4509, or BYK-4510. In some embodiments, the adhesion promoter is Lubrizol 2063, a hydroxy and carboxy functionalized phosphate ester.

In some embodiments, one or more additives of the aversive coating comprise a surfactant. Surfactants reduce the surface tension of a solution and may act as wetting agents and dispersants to assist in the application of the aversive coating to an electrochemical cell. In some embodiments, the dry-weight composition of the aversive coating comprises 0.01 wt % to about 1.0 wt % of the surfactant. In some embodiments, the surfactant is an alkyl sulfate, an alkyl ether sulfate, an alkyl benzene sulfonate, a polyoxyethylene ether, a phosphate ester, or a carboxylate. In some embodiments, the surfactant is sodium dodecyl sulfate (SDS), sodium lauryl ether sulfate (SLES), sodium stearate, Triton X-100, polysorbate 20 (Tween® 20), or dioctyl sodium sulfosuccinate (DOSS). In some embodiments, the surfactant is sodium dodecyl sulfate (SDS).

In some embodiments, the one or more additives of the aversive coating comprise a viscosity modifier to aid in dispensing a solution comprising the aversive coating. In some embodiments, the dry-weight composition of the aversive coating comprises 0.01 wt % to about 2.0 wt % of the viscosity modifier. In some embodiments, the viscosity modifier is a carbomer, a high molecular weight synthetic polymer of acrylic acid and allyl sucrose or allyl pentaerythritol, such as Carbopol® (e.g., Aqua SF-1, Aqua SF-3, Aqua CC, Silk 100, SC-800, 980 polymer, Ultrez 10, Ultrez 21) or Pemulen™ (e.g., TR-1, TR-2, EZ-4U). In some embodiments, the viscosity modifier is polyethylene glycol (PEG), which can have various molecular weights, such as PEG-400. In some embodiments, the viscosity modifier is a natural polysaccharide, such as xanthan gum, guar gum, or cellulose gum. In some embodiments, the viscosity modifier is a cellulose derivative such as carboxymethyl cellulose (CMC) or hydroxyethyl cellulose (HEC). Examples of viscosity modifiers include but are not limited to Viscolam®, Esaflor®, Ammonyx®, Ninol®, and Amphosol® thickening agents. In some embodiments, the viscosity modifier is carboxymethyl cellulose (CMC).

In an embodiment, the aversive coating has a dry-weight composition comprising about 2.0 wt % to about 3.0 wt % DNB, about 70 wt % to about 86 wt % PVA, and about 12 wt % to about 23 wt % carbon black.

In an embodiment, the aversive coating has a dry-weight composition comprising about 2.0 wt % to about 3.0 wt % DNB, about 35 wt % to about 45 wt % PVA, about 12 wt % to about 23 wt % carbon black, and about 40 wt % to about 45 wt % FD&C Blue No. 1.

### Electrochemical Cells

Aspects of the disclosure relate to electrochemical cells coated in the conductive aversive coatings described herein. The electrochemical cells comprise a positive terminal defining a first portion of an exterior of the electrochemical cell; a negative terminal that is electrically insulated from the positive terminal and defining a second portion of the exterior of the electrochemical cell; an anode positioned within an interior of the electrochemical cell and in electrical connection with the negative terminal; and a cathode positioned within the interior of the electrochemical cell, wherein the cathode is electrically separated from the anode and is in electrical connection with the positive terminal. At least a portion of the exterior surface of the electrochemical cell is coated with the aversive coatings provided herein. The electrochemical cell conducts electricity through the conductive aversive coating on the positive terminal and/or the negative terminal.

In some embodiments, the electrochemical cell is a button cell or a coin cell. In some embodiments, the electrochemical cell is a lithium coin cell. Lithium coin cells include but are not limited to CR1025, CR1216, CR1616, CR1620, CR1632, CR2016, CR2025, CR2032, CR2430, and CR2450 batteries. Coin cell batteries commonly have diameters of 10 mm, 16 mm, 20 mm, and 24 mm, which provide terminal areas of approximately 79 mm², 201 mm², 314 mm², and 452 mm² respectively.

Certain embodiments comprise electrochemical cells having an aversive coating covering at least part of at least one cell terminal (e.g., the positive terminal or the negative terminal). For example, the positive terminal may be coated with the aversive coatings, the negative terminal may be coated with the aversive coatings, or a portion of the positive terminal and/or a portion of the negative terminal may be coated with the aversive coatings (e.g., greater than 50%, by area, of the positive terminal; greater than 50%, by area, of the negative terminal; less than 50% by area, of the positive terminal; or less than 50%, by area, of the negative terminal).

In some embodiments, greater than 50% by area, greater than 60% by area, greater than 70% by area, greater than 75% by area, greater than 80% by area, greater than 85% by area, or greater than 90% by area of the positive terminal and/or the negative terminal is coated by the aversive coating. In some embodiments, 3% to 99% by area, 5% to 95% by area, 10% to 90% by area, 15% to 85% by area, 20% to 80% by area, 25% to 75% by area, 25% to 70% by area, 30% to 65% by area, 30% to 60% by area, 35% to 55% by area, 40% to 50% by area, 30% to 50% by area, 20% to 50% by area, 10% to 50% by area, or 5% to 50% by area of the positive terminal and/or negative terminal is coating by the aversive coating.

In some embodiments, greater than 50% by area of an exterior surface of the positive terminal is coated by the aversive coating. The exterior surface 25 of the positive terminal 20 is shown in FIGS. 2 and 3.

In some embodiments, greater than 50% by area of an exterior surface of the negative terminal is coated by the aversive coating. The exterior surface 17 of the negative terminal 12 is shown in FIGS. 2 and 3.

In some embodiments, the side wall of the gasket of the gasket is not coated with the aversive coating. The side wall 24 of the gasket 30 is shown in FIGS. 2 and 3.

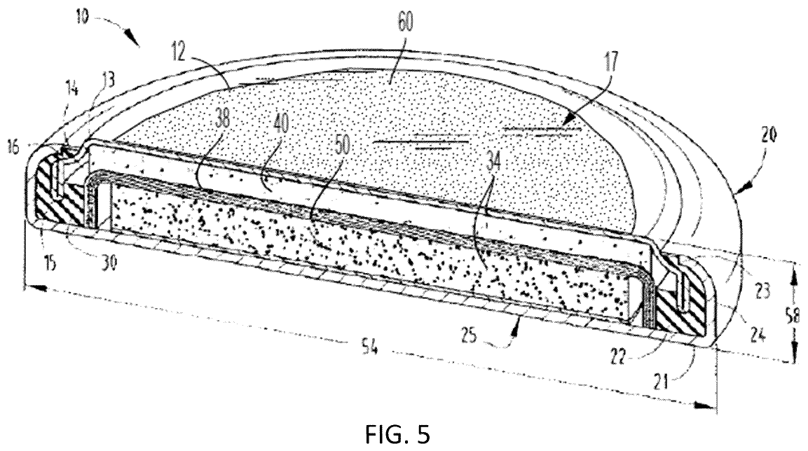

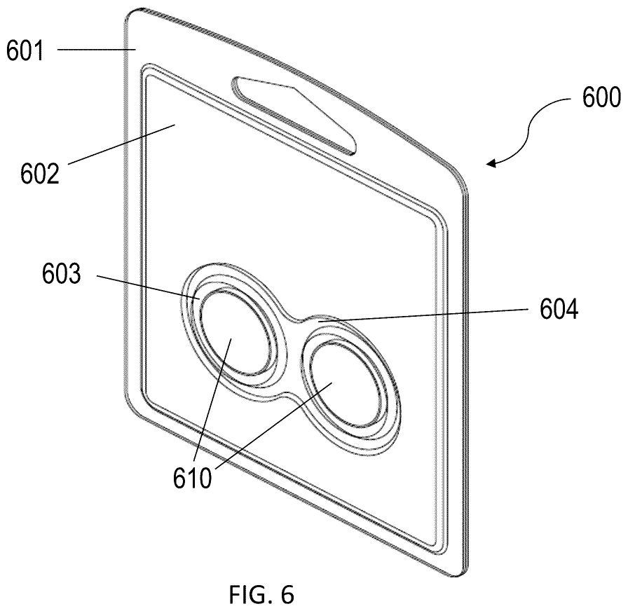

FIG. 5 shows an example of a coin cell 10 with a layer of conductive aversive coating 60 applied to the negative terminal, and FIG. 6 shows a schematic cutaway view of a coin cell with a thin layer of aversive coating 60 applied to the negative terminal.

In some embodiments, the aversive coating covers a circular area on the positive and/or the negative terminal. In some embodiments, the circular area covered with the aversive coating has a diameter of about 16 mm.

In some embodiments, the aversive coating is applied in a series of dots covering a portion of a negative terminal. In some embodiments, the aversive coating is applied as a plurality of dots forming an arc-shaped, ring-shaped, half-circle-shaped, or half-moon shaped area on the positive and/or negative terminal. In some embodiments, the dots have a diameter of about 0.7 mm to about 1.0 mm. In some embodiments, the area of the positive and/or negative terminal coated in aversive coating comprises a plurality of sub-arcs or sub-rings (e.g., concentric sub-arcs or sub-rings). In some embodiments, the area of the positive and/or negative terminal coated in aversive coating comprises 2, 3, 4, or 5 sub-arcs or sub-rings.

The aversive coating may also be applied in patterns including but not limited to stripes, rings, ovals, squares, rectangles, diamonds, triangles, half-circles or half-moon shapes. In some embodiments, the aversive coating is applied as one or more rectangular shapes. In some embodiments, the aversive coating is applied on two rectangular areas across the positive and/or negative terminal.

In some embodiments, the electrochemical cell is a coin cell or a button cell and the total area covered by aversive coating is about 10 mm² to about 200 mm², about 20 mm² to about 200 mm², about 30 mm² to about 200 mm², about 40 mm² to about 200 mm², about 50 mm² to about 200 mm², or about 50 mm² to about 100 mm².

In some embodiments, the aversive coating has a conductivity greater than 0.00001 S/m. In some embodiments, the aversive coating has a conductivity between 0.00001 S/m and 0.1 S/m.

In some embodiments, the electrochemical cell with greater than 50% area of the positive terminal and/or negative terminal coated by the aversive coating maintains a resistance of less than 68,000Ω, less than 60,000Ω, less than 50,000Ω, less than 40,000Ω, less than 30,000Ω, less than 20,000Ω, less than 10,000Ω, or less than 1,000Ω. In some embodiments, the electrochemical cell with greater than 50% area of the positive terminal and/or negative terminal voltage coated by the aversive coating maintains a resistance of less than 100Ω. Resistance (e.g. voltage/current) is affected by the conductivity of the aversive coating and the percentage of the area of the terminal that is coated in the aversive coating. For an electrochemical cell with a terminal coated in the aversive coating to maintain adequate performance, resistance from the coating must be sufficiently low. However, the threshold of a sufficiently low resistance to maintain performance may vary based on the type and application of the electrochemical cell. Electrochemical cells used in low-rate applications such as watch batteries use a constant, low current and thus can maintain performance with higher resistance from the aversive coating. For example, a CR2032 lithium coin cell used could have a thicker layer of aversive coating with a resistance of less than 68,000Ω, such as 10,000Ω while maintaining functionality as a watch battery. However, for electrochemical cells designed for higher rates of discharge, such as key fob batteries which use short bursts of higher currents, a lower resistance is necessary for performance. For an alkaline coin or button cell, such as an LR44 battery used in a key fob, to provide a current of 10 mA the resistance should be less than 100Ω to maintain a voltage of 1V. Accordingly, a more conductive aversive coating with very low resistance (<100Ω) may be used for devices with higher rates of discharge.

In some embodiments, the thickness of the aversive coating is greater than 1 μm. In some embodiments, the thickness of the aversive coating is about 1 μm to about 100 μm. In some embodiments, the thickness of the aversive coating is about 15 μm to about 20 μm.

In some embodiments, the total dry-weight amount of aversive coating applied to the electrochemical cell is about 0.2 mg to about 1.2 mg. In some embodiments, the total dry-weight amount of aversive coating applied to the electrochemical cell is about 0.4 mg to about 0.5 mg.

For sufficient aversive properties, at least 1 μg of an aversive taste agent is applied to each electrochemical cell. An amount of 1 μg of an aversive taste agent such as DNB has been found to be a sufficient quantity to provide an undesired taste to deter a child from eating an electrochemical cell. In some embodiments, the total amount of aversive taste agent applied to the electrochemical cell is between 1 μg to 50 μg, between 5 μg to 50 μg, between 5 μg to 40 μg, between 5 μg to 30 μg, between 10 μg to 30 μg, or between 10 μg to 25 μg. In some embodiments, the total amount of aversive taste agent applied to the electrochemical cell is about 25 μg.

In some embodiments, the electrochemical cell is packaged for sale in child-resistant packaging. The embodiment of FIG. 6 shows two batteries 610 positioned within the child-resistant packaging 600, although it should be understood that one battery or more than two batteries may be packaged within a single child-resistant packaging in other example embodiments. As shown, the child-resistant packaging may be embodied as a blister package, having a planar cardboard backing 601 and an overlaid thermoformed plastic layer 602 adhered onto a surface of the planar cardboard backing 601. In the illustrated embodiment, the thermoformed plastic layer 602 comprises a battery-holding portion 603 that is shaped to hold the one or more batteries that are enclosed within the packaging. The battery-holding portion 603 has an open end and defines a depression sized such that the one or more batteries fits entirely within the battery-holding portion 603, such that the planar cardboard backing 601 can be secured across the open end of the depression. Moreover, the plastic layer 602 additionally comprises a stiffening ridge encircling the battery-holding portion 603. The stiffening ridge 604 is hollow and extends in the same direction as the battery-holding portion 603. The stiffening ridge 604 provides additional stiffness to the child-resistant packaging 600, to impede a child from bending the child-resistant packaging 600 to release a battery stored therein.

The plastic layer 602 may comprise any of a variety of thermoplastics. For example, the plastic layer may be polyvinyl chloride (PVC), although other plastic materials may be utilized. The plastic layer may be sufficiently thick as to prevent a child from tearing the plastic layer. For example, the plastic layer may have a thickness of greater than 3 mil (e.g., between 3-7 mil).

As mentioned, the plastic layer 602 may be adhered to the planar cardboard backing 601 using an adhesive. For example, the adhesive may be a polyurethane-based adhesive, although other adhesives may be utilized. Greater than 50% of the area of the planar cardboard backing 601 may be adhered to planar portions of the plastic layer 602. A higher percentage of planar cardboard backing 601 being adhered to the plastic layer 602 increases the difficulty of a child removing the planar cardboard backing 601 from the plastic layer 602, thereby releasing the batteries therefrom. Accordingly, certain embodiments may adhere greater than 60%, greater than 70%, greater than 80%, or greater than 90%, by area, of the planar cardboard backing 601 onto the plastic material 602.

Moreover, as shown in FIG. 6, the plastic layer 602 may be sized to cover the entire area of planar cardboard backing 601. In this way, a child cannot bend the planar cardboard backing 601 to delaminate or otherwise release the plastic layer 602 from the surface of the planar cardboard backing 601.

Methods of Preparing Electrochemical Cells with Aversive Coatings

Described are methods of making electrochemical cells coated in aversive coatings. The electrochemical cells disclosed herein may be manufactured following any method known in the art. The method comprises preparing a coating solution by dissolving an aversive agent composition, a water-soluble polymer, and a conductive material in one or more solvents, applying the coating solution to at least part of the exterior of an electrochemical cell, and drying the solution onto the exterior of the electrochemical cell.

Coating solutions comprise 0.001 wt % to 5 wt % of the aversive taste agent, 5 wt % to 18 wt % of the water-soluble polymer, and 1.0 wt % to 14 wt % of the conductive material dissolved in one or more solvents. A water-soluble polymer, an aversive taste agent, and a conductive material are dissolved in a solvent to provide a coating solution with a final concentration of 5 wt % to 18 wt % of the water-soluble polymer, 0.001 wt % to 5 wt % of the aversive taste agent, and 1.0 wt % to 14 wt % of the conductive material.

In some embodiments, the coating solution further comprises 0.001 wt % to 18 wt % of a colorant. In some embodiments, the coating solution comprises 5 wt % to 18 wt % of FD&C Blue No. 1.

Additives in the coating solution such as surfactants and viscosity modifiers may also be used for the application of the aversive coating. In some embodiments, the coating solution further comprises 0.001 wt % to 0.1 wt % an adhesion promotor. In some embodiments, the coating solution further comprises 0.001 wt % to 0.2 wt % of a surfactant. In some embodiments, the coating solution further comprises 0.001 wt % to 0.1 wt % of a viscosity modifier.

In some embodiments, the coating solution is prepared by dissolving about 10 wt % PVA, about 0.55 wt % DNB, about 10 wt % FD&C Blue No. 1, and about 2 wt % to about 6 wt % of the conductive material in one or more solvents. In some embodiments, the coating solution is prepared by dissolving about 10 wt % PVA, about 0.55 wt % DNB, about 10 wt % FD&C Blue No. 1, and about 2 wt % to about 6 wt % of carbon black in one or more solvents. In some embodiments, the coating solution comprises about 2.9 wt % to about 5.7 wt % carbon black.

In some embodiments, the coating solution is prepared by dissolving about 10 wt % PVA, about 0.5 wt % to 2 wt % DNB, and about 12 wt % to 14 wt % of a conductive material in one or more solvents.

The concentrations of the water-soluble polymer, aversive agents, and conductive material in the coating solution may be adjusted as appropriate to provide dry-weight concentrations of the conductive aversive coatings within the described ranges.

The water-soluble polymer may be heated to an appropriate temperature for a period of time to fully dissolve in the coating solution. In some embodiments, the water-soluble polymer is PVA and the PVA is heated to about 95° C. for about 60 minutes to dissolve. In some embodiments, a solution of dissolved adhesion promoter (e.g., Lubrizol 2063) is added to the coating solution comprising the dissolved water-soluble polymer. In some embodiments, the coating solution that was heated to dissolve the water-soluble polymer is cooled before adding the aversive agent composition comprising the aversive taste agent, the conductive material and optionally the colorant.

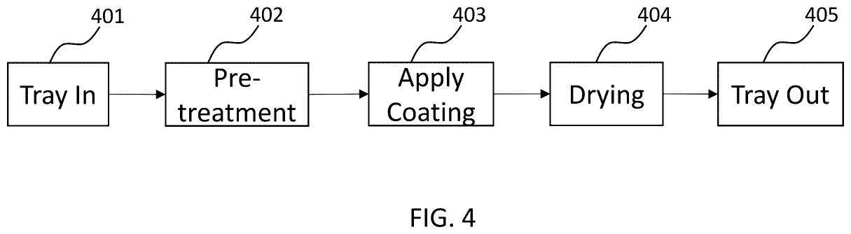

As shown in FIG. 4, a method of making the coated electrochemical cells on an assembly line may comprise bringing in a tray of electrochemical cells following manufacture of the electrochemical cells 401, performing a pre-treatment process 402, applying the coating solution 403, drying or curing the coating on the electrochemical cell 404, and bringing the tray out 405 for packaging.

The exterior surfaces of electrochemical cells may be cleaned after manufacture as a part of the pre-treatment process 402 and prior to applying the coating solution 403. Removing grease or residue from the manufacturing process may facilitate adherence of the coating solution to the electrochemical cell. In some embodiments the electrochemical cell is sprayed with deionized water for a period of time (e.g., 5 to 10 seconds) prior to applying the coating solution. In some embodiments, the electrochemical cell is rinsed at a temperature higher than room temperature (e.g., 27° C. to 35° C.). The electrochemical cell may be dried prior to applying the coating solution. In some embodiments, the electrochemical cell is dried with hot air after rinsing for a period of time (e.g., 1 to 5 seconds). In some embodiments, the electrochemical cell is dried with air at a temperature of about 25° C.

The aversive coating may be applied to the electrochemical cell following any method known in the art. In some embodiments, the coating solution is applied by dipping, spraying, printing, or dispensing the coating solution on the electrochemical cell. Dipping all or part of the electrochemical cell into the coating solution may be used to apply the aversive coating to the electrochemical cell. The coating solution may also be sprayed onto one or both terminals to apply the aversive coating. In embodiments where only a portion of the positive or negative terminal is coated with the aversive coating, a mask may be used to selectively apply the aversive coating to the desired portions of the electrochemical cell. The mask is a solid non-absorptive material with holes or gaps of a desired pattern and is placed between the electrochemical cell and apparatus dispensing the coating solution to allow the coating solution to be deposited (e.g., with spraying or dipping) on a specific portion of the electrochemical cell. The mask may be removed after the aversive coating has dried.

In some embodiments, the coating solution is applied to greater than 50%, greater than 60%, greater than 70%, greater than 75%, greater than 80%, greater than 85%, greater than 90%, or greater than 95% of the area of the positive and/or negative terminal.

### Discussion and Examples

As discussed herein, bitterants, colorants, salivating agents, and/or other aversive agents may be added to at least a portion of the exterior of a coin cell battery to deter individuals (e.g., children) from ingesting the batteries. For example, one or more aversive agents such as denatonium benzoate (DNB) and colorant may be added in a coating that adheres to an exterior surface of the battery. Water-soluble polymers such as but not limited to PVA and polyacrylic acid (PAA) may be used as a binder to the battery surface.

However, the aversive agents and polymers in existing aversive coatings are non-conductive materials, which may interfere with the electrical connection to a device if the coating is located on a terminal at a contact point. Adding a conductive material in sufficient quantity to create a conductive matrix through the coating may result in improved cell performance during discharge of a cell with a coating over at least a portion of the terminals. Specifically, if the conductive material is added to a polymeric material at a concentration greater than a percolation threshold, electricity can be conducted through the composite material. This percolation threshold is reached when paths of touching conductive particles are established across the polymer matrix composite.

In order to test the feasibility of conductive coatings and determine a percolation threshold for carbon black as a conductive material, aversive coatings were prepared with different concentrations of a carbon black as the conductive material. A base coating solution was prepared with 10 wt % PVA (with an average molecular weight of 72,000), 0.55 wt % denatonium benzoate (DNB), and 10 wt % FD&C Blue No. 1 in deionized water. Coating solutions were prepared by adding 1.0 wt %, 2.90 wt %, and 5.7 wt % of a carbon black material and were applied to the negative terminal of lithium coin cells. Upon drying, the coatings contained 4.6 wt %, 12.7 wt % and 22.6 wt % of the carbon black, respectively.

The conductivity of the coated cells was tested with a voltmeter in several areas with both dull and sharp probes. No connection was established for coated cells without carbon black (demonstrating no conductivity through the coatings of these cells). High resistance was observed (e.g., over 10,000-10,000,000Ω) for the cells coated with 4.6 wt % carbon black, but a full connection was established for cells coated with 12.7 wt % and 22.6 wt % carbon black. The open circuit voltage (OCV) measured for cells coated with 12.7 wt % and 22.6 wt % carbon black was consistent with the OCV of non-coated cells (e.g., about 3.3 V). Conversely, all of the cells coated without carbon black and many of the cells coated with 4.6 wt % carbon black provided very low OCV readings (e.g., less than 0.03 V). The resistance for cells coated with 22.6 wt % carbon black (e.g., around 100-300 (2) was lower than the resistance for cell coated with 12.7 wt % carbon black (e.g., around 200-10,000 (2). These results indicate the percolation threshold for carbon black with the specific type and concentration of PVA tested is around 12 wt %. Without being bound by theory, percolation thresholds may vary based on the type of conductive material and the type and concentration of water-soluble polymer used.

In some embodiments, a conductive material, such as carbon black, graphite, expanded graphite, graphene, carbon nanotubes, and/or the like, is added to the coating mixture in a sufficient concentration to create conductive networks throughout the mixture once dry on the surface of a cell. In one embodiment, a water-soluble polymer such as polyvinyl alcohol (PVA) is added to the aversive agent solution, so the aversive agent and conductive material is encapsulated in a PVA network and applied to a battery surface. When the water of the aversive agent solution evaporates, the polymer acts as a binder and binds aversive agent(s) and conductive material (and other active materials, such as a colorant and/or a salivating agent) to the battery surface. However, the coating remains soluble in water (or a water-like solution, such as saliva), such that the aversive agent is released from the surface of the battery when a human (e.g., a child) places the battery in his/her mouth. The unpleasant taste of the aversive agent may cause the human to spit out the battery, rather than swallowing it.

The polymer may be a low molecular weight polymer (1-10Ks), a medium molecular weight polymer (10-100Ks), or a high molecular weight polymer (>100Ks). Low molecular weight polymers have high water solubility, and the shorter chains provide less chain entanglement and higher molecular mobility. However, low molecular weight polymers tend to form beads rather than fibers in solution and provide weaker materials. High molecular weight polymers have low water solubility but experience a higher degree of chain entanglement and form films with high tensile strength. Higher molecular weight polymers also tend to form tougher and more chemically resistant materials. Additionally, the viscosity of a solution containing a polymer increases with the molecular weight. Medium molecular weight polymers have intermediate water solubility, strength and viscosity.

The conductive material may be provided in the coating composition at a concentration to create conductive pathways through the coating. As an example, the conductive material may be added at a concentration of 6% or greater (e.g., 6%-70%), such as 12% or greater (e.g., 12%-70%), 20% or greater (e.g., 20% to 70%), 22% or greater (e.g., 22% to 70%), and/or the like. In some embodiments, the conductive material may be added at a concentration of between about 12% to about 23%. All percentages are weight percentages by dry weight of the coating.

The quantity of aversive agent may be selected to provide an undesired taste of the battery. For example, an amount of DNB may be selected to be between 4-120 μg (e.g., between 5-30 μg) for each coin cell. Aversive agents may include substances that elicit strongly unpleasant tastes or smells such as spicy, peppery, sour, bitter, or odiferous. Examples include: capsaicin, allyl isothiocyanate, and piperine.

The coating can be applied after preparing the surface of the battery (e.g., providing a primer to the surface of the battery, cleaning the surface of the battery, or treating the surface of the battery) using many different coating methods, such as providing small droplets of material (e.g., via a pipet). Other application methods comprise dip rinsing the battery, spraying the battery, pad printing onto the battery, screen printing onto the battery, needle dispensing onto the battery, and/or the like. Any method may be used, so long as it deposits the thin layer uniformly. In certain embodiments, the coating may be applied directly to the surface of the battery and the coating may include an adhesion promoter.

In certain embodiments, additional additives may be provided to further increase desired characteristics of the resulting coating. For example, a surfactant can be added to the solution to increase the wettability of the coating. In certain embodiments, the battery surface can also be treated by plasma ultra-sonic or other means to increase surface energy to better accept the coating.

When coating a terminal (e.g., the negative terminal), a portion of the terminal may be masked (e.g., the outermost 1-2 mm to prevent shorting when wetted with the solution) so that the masked portion is not coated with the coating material and/or is not primed or treated as discussed herein. The coating material may then be sprayed onto the terminal, and then the mask may be removed after the coating has dried.

The coating solution itself may have a composition of the following: a solvent (comprising, for example, water, isopropanol, ethanol, mixtures thereof, and/or other organic solvent materials); DNB (or other aversive agents), conductive material (e.g., carbon black, graphite, expanded graphite, graphene, carbon nano-tubes, and/or the like), optional additives (e.g., surfactants, adhesion promotors, etc.), optional low concentrations of polymeric binders (e.g., PVA, PAA, polyethylene glycol, polyacrylamides, and/or the like), optional viscosity modifiers for better processing (e.g., Carboxymethylcellulose (CMC)). In certain embodiments, the coating may additionally comprise an adhesion promoter (e.g., DowSil Z-6137, Dowsil 3-6121, Lubrizol-2062, Lubrizol 2063H, PP-6, and/or the like). The coating may be applied via a spray.

Prior to coating, the battery may be cleaned or otherwise prepared to remove manufacturing oil residues on the surface of the battery. For example, the battery may be rinsed in deionized water (e.g., cyclically treated deionized water having a conductivity σ<10 uS/cm) for a total of 8 seconds at 30° C. The battery may be hot air dried beginning 0.5 seconds after the rinse is completed. The hot air dry has a duration of approximately 3 seconds at an air temperature of 25° C.

The coating may be sprayed onto the cleaned battery surface, approximately 1 second after air drying is complete. The battery may then be dried (e.g., via hot air drying) to dry the coating onto the cell. If a portion of the cell was masked, the mask may be removed after drying the coating.

As examples, the coatings may be provided on the positive terminal and/or the negative terminal of the battery. The coatings may be provided over a portion of the positive terminal and/or the negative terminal, leaving the remainder of the terminal exposed. In other embodiments, the coatings may be provided over substantially the entirety of the positive terminal and/or the negative terminal.

### CONCLUSION

Many modifications of the embodiments set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the present application. Generally the term “about”, as used herein when referring to a measurable value such as an amount of weight, time, dose, etc. is meant to encompass in one example variations of ±20%, in another example±10%, in another example±5%, in another example±1%, and in yet another example±0.1% from the specified amount, as such variations are appropriate to perform the disclosed method.

All examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features and steps are not limited to serial execution, but rather may be executed asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations that are disclosed and may not explicitly recited. As such, it should be understood that advantages, embodiments, examples, functional, features, logical, operational, organizational, structural, topological, and/or other aspects of the disclosure are not to be considered limitations on the disclosure as defined by the embodiments, examples, claims or limitations on equivalents to the embodiments, examples, and/or claims. It is to be understood that, depending on the particular needs and/or characteristics of an electrochemical cell, such as a coin cell battery or the like, various embodiments or portions of various embodiments of the coin cell batteries described herein may be implemented that allow a great deal of flexibility and customization.

The invention claimed is:

1. An electrochemical cell comprising:
a positive terminal;
a negative terminal that is electrically insulated from the positive terminal, wherein the positive terminal and the negative terminal collectively define an exterior of the electrochemical cell;
an anode positioned within an interior of the electrochemical cell and in electrical connection with the negative terminal; and
a cathode positioned within the interior of the electrochemical cell, wherein the cathode is electrically separated from the anode and is in electrical connection with the positive terminal,
wherein at least a portion of an exterior surface of the electrochemical cell is coated with a conductive aversive coating such that electricity is conducted from at least one the positive terminal or the negative terminal through the conductive aversive coating, wherein the conductive aversive coating has a dry-weight composition comprising:
0.5 wt % to 60 wt % of an aversive agent composition;
35 wt % to 90 wt % of a water-soluble polymer; and
3.0 wt % to 55 wt % of a conductive material.

2. The electrochemical cell of claim 1, wherein the aversive agent composition comprises at least one aversive taste agent selected from: denatonium benzoate (DNB), capsaicin, allyl isothiocyanate, or piperine.

3. The electrochemical cell of claim 2, wherein the conductive aversive coating comprises 0.5 wt % to 7.0 wt % of the aversive taste agent.

4. The electrochemical cell of claim 1, wherein the water-soluble polymer is selected from: polyvinyl alcohol (PVA), polyacrylic acid (PAA), polyacrylamide, or polyethylene glycol (PEG).

5.-8. (canceled)

9. The electrochemical cell of claim 1, wherein the conductive material comprises carbon.

10. The electrochemical cell of claim 9, wherein the conductive material is carbon black, graphite, expanded graphite, graphene, or carbon nanotubes.

11. The electrochemical cell of claim 10, wherein the conductive material is carbon black.

12. The electrochemical cell of claim 1, wherein the conductive aversive coating comprises 9.0 wt % to 30.0 wt % of the conductive material.

13. The electrochemical cell of claim 1, wherein the conductive aversive coating comprises 12 wt % to 23 wt % of the conductive material.

14. The electrochemical cell of claim 1, wherein the aversive agent composition comprises a colorant and the conductive aversive coating comprises 0.5 wt % to 60 wt % of the colorant.

15. The electrochemical cell of claim 14, wherein the colorant comprises: FD&C Blue No. 1, FD&C Blue No. 2, FD&C Green No. 3, FD&C Red No. 3, FD&C Red No. 40, FD&C Yellow No. 5, or FD&C Yellow No. 6.

16.-17. (canceled)

18. The electrochemical cell of claim 1, wherein the electrochemical cell is a button cell or a coin cell.

19. The electrochemical cell of claim 18, wherein the total dry-weight amount of aversive coating applied to the electrochemical cell is about 0.2 mg to about 1.2 mg.

20. The electrochemical cell of claim 1, wherein the aversive coating covers greater than 50% of the area of at least one of the positive terminal or the negative terminal.

21. The electrochemical cell of claim 1, wherein the thickness of the aversive coating is greater than 1 μm.

22. The electrochemical cell of claim 1, wherein the aversive coating has a conductivity greater than 0.00001 S/m.

23. The electrochemical cell of claim 20, wherein the electrochemical cell maintains a resistance of less than 68,000Ω, less than 60,000Ω, less than 50,000Ω, less than 40,000Ω, less than 30,000Ω, less than 20,000Ω, less than 10,000Ω, or less than 1,000 Ω.

24. The electrochemical cell of claim 1, wherein the electrochemical cell is packaged in child-resistant packaging.

25. A method of preparing a child-safe electrochemical cell, wherein at least a portion of an exterior of the electrochemical cell is coated with a conductive aversive coating, wherein the aversive coating has a dry-weight composition comprising 0.5 wt % to 60 wt % of an aversive agent composition, 35 wt % to 90 wt % of a water-soluble polymer, and 3.0 wt % to 55 wt % of a conductive material, the method comprising:
preparing a coating solution, wherein the coating solution comprises 0.001 wt % to 5 wt % of an aversive taste agent, 5 wt % to 18 wt % of a water-soluble polymer, and 1.0 wt % to 14 wt % of a conductive material dissolved in one or more solvents;
applying the coating solution to greater than 50% of an area of a positive or negative terminal of an electrochemical cell; and
drying the solution onto the exterior of the electrochemical cell.

26. (canceled)

27. A conductive aversive coating comprising:
0.5 wt % to 60 wt % of an aversive agent composition;
35 wt % to 90 wt % of a water-soluble polymer; and
3.0 wt % to 55 wt % of a conductive material.

28.-43. (canceled)
